(19) United States
(12) Patent Application Publication
(10) Pub. No.: US 2026/0238254 A1
(43) Pub. Date: Aug. 13, 2026

(54) POSITIONING ENHANCEMENTS ABOUT TRANSMISSION COLLISION IN SRS FREQUENCY HOPPING

(71) Applicant: Telefonaktiebolaget LM Ericsson (publ), Stockholm (SE)

(72) Inventors: Zhilan XIONG, Solna (SE); Chunhui ZHANG, Stockholm (SE); Florent MUNIER, Västra Frölunda (SE)

(21) Appl. No.: 19/156,686

(22) PCT Filed: Jan. 31, 2024
(86) PCT No.: PCT/SE2024/050084

§ 371 Date: Aug. 14, 2025

Related U.S. Application Data
(60) Provisional application No. 63/485,737, filed on Feb. 17, 2023.

(51) Int. Cl. H04B 1/7143; H04B 1/715; H04L 5/00; H04W 64/00

(52) U.S. Cl. CPC H04B 1/7143; H04B 1/715; H04L 5/0051; H04W 64/00

(57) ABSTRACT

A method implemented in a wireless device for sounding reference signaling, SRS, transmission with frequency hopping, a method implemented in a network node for SRS transmission with frequency hopping, a wireless device and a network node are disclosed. A method implemented in a wireless device for sounding reference signaling transmission with frequency hopping includes determining at least one SRS symbol used for positioning purpose in the SRS transmission with frequency hopping to be dropped, wherein the at least one SRS symbol used for positioning purpose in the SRS transmission collides with at least one other signaling, and dropping the at least one SRS symbol used for positioning purpose in the SRS transmission.

### TECHNICAL FIELD

The present disclosure relates to wireless communications, and in particular, to supporting configurations for positioning enhancements in sounding reference signal (SRS) transmission with frequency hopping.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

For 3GPP Release 17 (Rel-17), an NR User Equipment (UE) type (i.e., WD type) with lower capabilities has been proposed. A Machine Type Communication (MTC) version of NR, i.e., Reduced Capability NR (NR-RedCap) device (also referred to as a RedCap UE and/or RedCap WD) has been proposed for existing systems.

Low-cost or low-complexity WD (e.g., UE) implementation has been proposed, e.g., for massive industrial sensors deployment or wearables. In some existing systems, an NR-RedCap device is one such low-complexity WD for 3GPP. For example, an NR-RedCap device may be intended for use cases that do not require a device to support full-fledged capability and/or performance requirements. For example, the data rate does not need to reach above 1 Gigabits per second (Gbps), and the latency does not need to be as low as 1 millisecond (ms). By relaxing the data rate and latency targets, NR-RedCap may allow for low-cost or low-complexity WD implementation. For example, in 3GPP Release 15, an NR WD (e.g., UE) may be required to support 100 Megahertz (MHz) carrier bandwidth in frequency range 1 (from 410 MHz to 7125 MHz) and 200 MHz carrier bandwidth in frequency range 2 (from 24.25 GHz to 52.6 GHz). For RedCap WDs, supporting 100 MHz or 200 MHz bandwidth may be superfluous for certain use cases. For example, a WD bandwidth of 8.64 MHz may be sufficient if a use case does not require a data rate higher than 20 Megabits per second (Mbps). Reduced WD bandwidth results in complexity reduction and possibly energy consumption reduction as well.

3GPP is discussing NR positioning as part of 3GPP Release-18(Rel-18 ) with potential enhancements for RedCap positioning in which the maximal bandwidth of RedCap UE is 20 MHz in FR1 and 100 MHz in FR2. One of the potential solutions is to introduce SRS frequency hopping for the positioning accuracy improvement of uplink-related RedCap positioning.

Current specification in 3GPP Technical Specification (TS) 38.214.

In some existing systems, if a physical uplink shared channel (PUSCH) with a priority index 0 and SRS configured by SRS-Resource are transmitted in the same slot on a serving cell, the WD may only be configured to transmit SRS after the transmission of the PUSCH and the corresponding demodulation reference signalling (DM-RS).

If a PUSCH transmission with a priority index 1 or a physical uplink control channel (PUCCH) transmission with a priority index 1 would overlap in time with an SRS transmission on a serving cell, the WD does not transmit the SRS in the overlapping symbol(s), according to configurations in existing systems.

In some existing systems, for PUCCH and SRS on the same carrier, a WD may not transmit SRS when semi-persistent or periodic SRS is configured in the same symbol(s) with PUCCH carrying only channel state information (CSI) report(s), or only Open Systems Interconnection (OSI) Layer 1 (also referred to herein as Layer 1 or L1) reference signal received power (L1-RSRP) report(s), or only Layer 1 Signal to Interference and Noise Ratio (L1-SINR) report(s). A WD may not transmit SRS when semi-persistent or periodic SRS is configured or aperiodic SRS is triggered to be transmitted in the same symbol(s) with PUCCH carrying HARQ-ACK, link recovery request (as defined in clause 9.2.4 of [6, 38.213]) and/or scheduling request (SR). In the case that SRS is not transmitted due to overlap with PUCCH, only the SRS symbol(s) that overlap with PUCCH symbol(s) are dropped. The PUCCH may not be transmitted when aperiodic SRS is triggered to be transmitted to overlap in the same symbol with PUCCH carrying semi-persistent/periodic CSI report(s) or semi-persistent/periodic L1-RSRP report(s) only, or only L1-SINR report(s).

In some existing systems, for operation on the same carrier, if an SRS configured by the higher parameter SRS-PosResource collides with a dynamically scheduled PUSCH with high priority, the SRS may be dropped in the symbols where the collision occurs, e.g., as mentioned in TS 38.214. For example, for a low priority PUSCH, the rule is that SRS and PUSCH sent in the same slots are sent in sequence, with the PUSCH coming first and the SRS second.

RedCap WDs have limited bandwidth and for the purpose of positioning, a wider bandwidth is desirable. In Rel-18, the SRS for positioning may be adapted for RedCap WDs, in order to allow sounding in multiple hops which can be stitched together to create a wide, coherent transmission. One way to realize the hopping pattern is to use more than multiple SRS resources which slightly overlap in order to span the target bandwidth. If the partial overlapped resources of one hop of the SRS resources would be lost due to PUSCH collisions, the remaining resources will be unusable at the receiver, because all of the resources must be received in order to compensate the phase errors experienced by the WD when switching carrier frequency between hops. A rule needs to be defined so that the WD would not need to transmit more SRS occasions than necessary and thus to save power.

Existing solutions, however, are designed for wideband SRS transmission, without the consideration of narrowband SRS frequency hopping across wideband. Thus, existing systems lack configurations, e.g., for handling such collision.

### SUMMARY

Some embodiments advantageously provide methods, systems, and apparatuses for supporting configurations for positioning enhancements in SRS transmission with frequency hopping.

According to a first aspect of embodiments herein, the object is achieved by a method performed by a wireless device, WD, for sounding reference signaling, SRS, transmission with frequency hopping. The method comprises: determining at least one SRS symbol used for positioning purpose in the SRS transmission with frequency hopping to be dropped, wherein the at least one SRS symbol used for positioning purpose in the SRS transmission collides with at least one other signaling; and dropping the at least one SRS symbol used for positioning purpose in the SRS transmission.

According to a second aspect of embodiments herein, the object is achieved by a wireless device, WD, configured to communicate sounding reference signaling, SRS, transmission with frequency hopping with a network node. The WD is configured to, and/or comprising a radio interface and/or processing circuitry configured to determine at least one SRS symbol used for positioning purpose in the SRS transmission with frequency hopping to be dropped, wherein the at least one SRS symbol used for positioning purpose in the SRS transmission collides with at least one other signaling; and drop the at least one SRS symbol used for positioning purpose in the SRS transmission.

According to a third aspect of embodiments herein, the object is achieved by a method performed by a network node for sounding reference signaling, SRS, transmission with frequency hopping. The method comprises: transmitting to a wireless device, WD, a configuration for uplink, UL, SRS; receiving from the WD the SRS transmission with frequency hopping based on the configuration; and processing SRS in the received SRS transmission; wherein the received SRS transmission comprises at least one other signaling rather than at least one SRS symbol used for positioning purpose, wherein the at least one SRS symbol used for positioning purpose collides with the at least one other signaling and is dropped.

According to a fourth aspect of embodiments herein, the object is achieved by a network node configured to communicate sounding reference signaling, SRS, transmission with frequency hopping with a wireless device, WD. The network node is configured to, and/or comprising a radio interface and/or comprising processing circuitry configured to: transmit to the WD a configuration for uplink, UL, SRS; receiving from the WD the SRS transmission with frequency hopping based on the configuration; and process SRS in the received SRS transmission; wherein the received SRS transmission comprises at least one other signaling rather than at least one SRS symbol used for positioning purpose, and wherein the at least one SRS symbol used for positioning purpose collides with the at least one other signaling and is dropped.

Embodiments of the present disclosure may provide configurations for the WD to save power, e.g., by avoiding transmitting SRS resources which would not be usable for the purpose they were configured for, e.g. bandwidth hopping.

Embodiments of the present disclosure may be used to solve a collision between UL SRS transmission and scheduled PUSCH/PUCCH transmission.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node for supporting configurations for positioning and transmission collision in SRS frequency hopping according to some embodiments of the present disclosure;

FIG. 8 is a flowchart of an exemplary process in a wireless device for supporting configurations for positioning and transmission collision in SRS frequency hopping according to some embodiments of the present disclosure;

FIG. 9 is a flowchart of an exemplary process in a wireless device for supporting positioning enhancements in SRS transmission with frequency hopping according to some embodiments of the present disclosure;

FIG. 10 is a flowchart of an exemplary process in a network node for supporting positioning enhancements in SRS transmission with frequency hopping according to some embodiments of the present disclosure;

FIG. 11 is a diagram illustrating an example configuration according to some embodiments of the present disclosure;

FIG. 12 is a diagram illustrating another example configuration according to some embodiments of the present disclosure;

FIG. 13 is a diagram illustrating another example configuration according to some embodiments of the present disclosure;

FIG. 14 is a diagram illustrating another example configuration according to some embodiments of the present disclosure;

FIG. 15 is a diagram illustrating another example configuration according to some embodiments of the present disclosure; and

FIG. 16 is a diagram illustrating another example configuration according to some embodiments of the present disclosure.

### DETAILED DESCRIPTION

Before describing in detail exemplary embodiments, it is noted that the embodiments reside primarily in combinations of apparatus components and processing steps related to supporting configurations for positioning and transmission collision in SRS frequency hopping. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, a Narrowband IoT (NB-IOT) device, a RedCap WD, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the present disclosure provide configurations for updating (e.g., modifying over existing solutions) the dropping rules for WDs and/or network nodes, e.g., to also include the SRS resources that are not colliding with PUSCH/PUCCH, but participate in the same sounding transmission as a colliding SRS resource.

One or more embodiments of the present disclosure may be characterized by one or more of the following:
PUSCH can be interchangeable with PUCCH;
The terminology “narrowband” may be interchangeable with the terminology “bandwidth part, BWP”;
PUSCH and/or PUCCH may be replaced by SRS for other purpose(s) rather than SRS for positioning.

Embodiments of the present disclosure may be described by one or more of the following examples:
Example 1: In some embodiments, the WD (and/or network node) may be configured for operation on the same wideband carrier, such that if any symbol of any resource involved in an SRS transmission occasion configured by the network node collides with any symbol of a scheduled high priority PUSCH in time domain or collides with the minimal required time gap for RF retuning from SRS hop in one narrowband to this scheduled high priority PUSCH in other narrowband in time domain, or collides with the minimal required time gap for RF retuning from this scheduled high priority PUSCH in one narrowband to SRS hop in another narrowband, the SRS in all resources in this SRS transmission occasion is dropped, according to some configurations at the WD and/or network node. Alternatively, only SRS in collision symbol(s) is dropped, according to some configurations at the WD and/or network node.
Example 3: The WD and/or network node may be configured such that a collision with the scheduled PUSCH/PUCCH may occur during any hop at the beginning, middle and/or end of the full frequency hopping sequence (FH1, FH2, . . . , FHk). The collision of SRS and PUSCH may occur only partially in at least one frequency hop (FH) depending on how many SRS symbols are configured to transmit within each hop. Note that the collision includes the symbols for high priority PUSCH/PUCCH transmission, and the symbols used for RF retuning from SRS hop in one narrowband to the scheduled high priority PUSCH/PUCCH in another narrowband and the symbols used for RF retuning from the scheduled high priority PUSCH/PUCCH in one narrowband to SRS hop in another narrowband.
   If the collision symbols of SRS and PUSCH/PUCCH with priority index 1 are all symbols scheduled for SRS transmission for this hop and the collision slot (another example is the “collision hop”) is the first hop, middle hop, or end hop within a frequency hopping sequence, the WD (and/or network node) may be configured to drop the frequency hops following the collision hop in the frequency hopping sequence. In this case, the network node may be configured to only process the SRS stitching if full frequency hops in this frequency hop sequence would be received.
   If the collision symbols of SRS and PUSCH/PUCCH with priority index 1 are all symbols scheduled for SRS transmission for this hop and the collision slot (another example is the “collision hop”) is the first or middle hop within a frequency hopping sequence, the WD may be configured to NOT drop the rest of the frequency hops but continue with the rest of the hops for the configured FH pattern/sequency. In this case, the network node may be configured to process the SRS stitching if partially frequency hops would be received. In this case, the network node may be configured to inform a location server of the aggregated bandwidth for the measurement results (e.g., timing of arrival, related timing difference, and so on).
   In some embodiments, the WD and/or network node may be configured so that the same collision dropping rule in legacy specification may apply within each SRS hop.
   In some embodiments, if the collision symbols of SRS and PUSCH/PUCCH with priority index 1 are all symbols scheduled for SRS transmission for this hop and the collision slot (another example is the “collision hop”) is the first hop, middle hop, or end hop within a frequency hopping sequence, then:
      WD behavior (e.g., based on configuration information):
         Alt. Example 1: the WD may drop the frequency hops following the collision hop in the frequency hopping sequence.
         Alt. Example 2: the WD may drop the collision hop and the following frequency hops in the frequency hopping sequence.
         Alt. Example 3: the WD may drop the collision hop in the frequency hopping sequence.
      Network node behavior (e.g., based on configuration information):
         Alt. Example 1: the network node may only process the SRS stitching if full frequency hops in this frequency hop sequence would be received.
         Alt. Example 2: the network node may only process the SRS stitching if full frequency hops in this frequency hop sequence have been detected.
         Alt. Example 3: the network node may only process the SRS stitching if partially frequency hops would be received. In other words, the network node may only process the transmitted SRS hops in this frequency hop sequence.
         Alt. Example 4: the network node may only process the detected SRS hops in this frequency hop sequence.
         The Network node may inform the location server of at least one of the aggregated bandwidth, the symbols in each hop and the minimal available SRS symbols in the hops for the related measurement results (e.g. timing of arrival, related timing difference, and so on), for example from the network node to the location server.
         The network node may inform the location server of the reason of the failure of the measurement.
Example 4: If a PUSCH transmission with a priority index 1 or a PUCCH transmission with a priority index 1 would overlap in time with an SRS transmission for the purpose of bandwidth hopping on a serving cell, the WD (e.g., based on configuration information) does not transmit any symbol of the SRS resource and does not transmit the SRS resource(s) configured for the same bandwidth hopping.
Example 5: If a PUSCH with a priority index 0 and an SRS configured by SRS-PosResource for the purpose of bandwidth hopping are transmitted in the same slot on a serving cell, the WD (e.g., based on configuration information) may only be configured to transmit SRS after the transmission of the PUSCH and the corresponding DM-RS.

In some embodiments, one SRS transmission occasion may be defined as the time-frequency resources including one whole narrowband SRS frequency hopping cross target wideband. Other definitions of one SRS transmission occasion may be used without deviating from the scope of the present disclosure.

Embodiments of the present disclosure may provide:

At the WD side, the SRS for positioning in non-conflicted symbols may be dropped.

At the network node side, the network node (e.g., base station) may inform the location server (e.g., a cloud-based location server and/or core network location server) of the aggregated bandwidth and/or the positioning accuracy and/or the positioning accuracy uncertainty for the measurement results of SRS frequency hopping.

As used herein, “drop” or “dropped” may refer to a WD being configured with a first configuration which schedules an SRS to be transmitted on a first resource, and then determining, e.g., based on another condition/configuration, etc., that the WD is configured to not transmit the signal (e.g., SRS signaling) on the transmission resource, e.g., because of a collision with another scheduled signal on at least part of the same first resource. The WD may instead transmit other signalling (e.g., data signalling control signalling, signalling on other channels, etc.) on the dropped resource(s). The resources may be any of symbols (e.g., time domain symbols, OFDM symbols, etc.), resource elements, slots, minislots, physical resource blocks, etc. Similarly, the network node may determine which signals (e.g., SRS transmissions on resources) the WD may drop, based on being configured with information regarding which configuration(s) the WD may apply, e.g., under conditions known the network node, so that the network node may be configured to process (and/or ignore, not process, process differently according to other signalling configurations, process other signalling on the resources instead of the SRS signalling, etc.) the signaling received from the WD.

Some embodiments provide configurations for positioning and transmission collision in SRS frequency hopping.

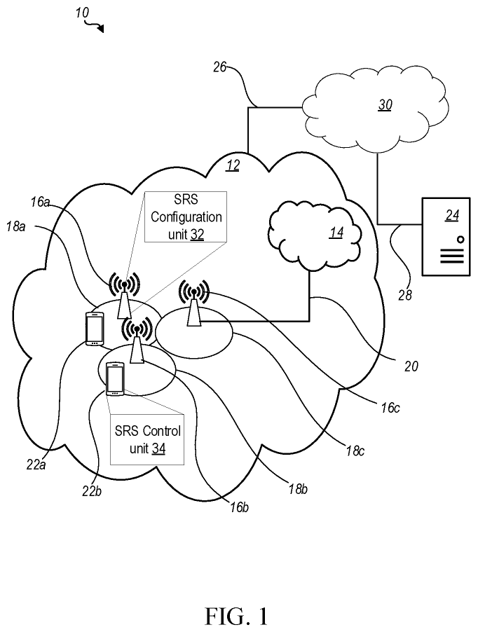

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an SRS Configuration unit 32 which is configured for supporting configurations for positioning and transmission collision in SRS frequency hopping. A wireless device 22 is configured to include an SRS Control unit 34 which is configured for supporting configurations for positioning and transmission collision in SRS frequency hopping.

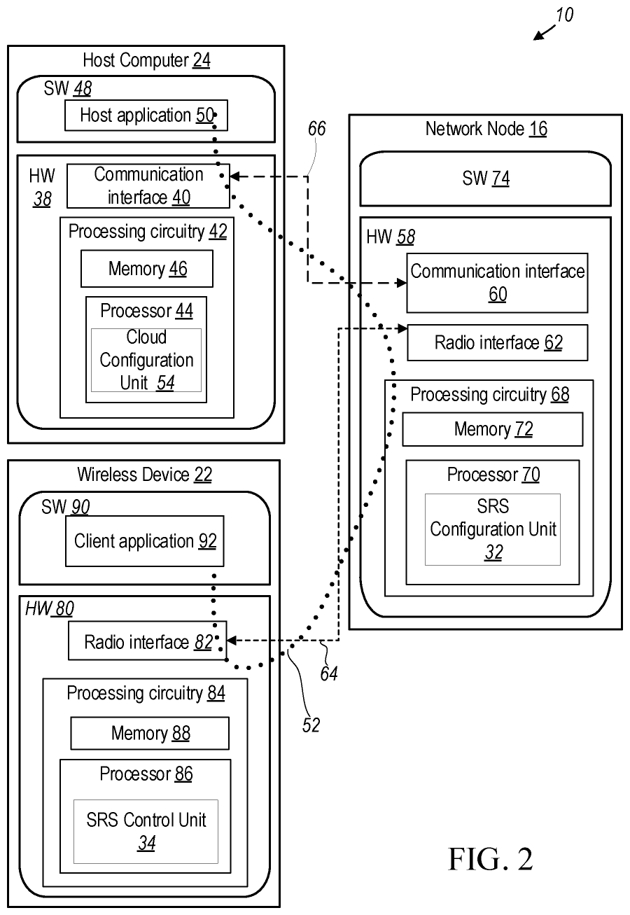

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software (SW) 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software (SW) 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Cloud Configuration unit 54 configured to enable the service provider to observe/monitor/control/transmit to/receive from/etc. the network node 16 and or the wireless device 22, e.g., for supporting configurations for positioning and transmission collision in SRS frequency hopping. For example, host computer 24 (e.g., via Cloud Configuration unit 54) may implement, provide, correspond to, etc., a location server, which may provide one or more location/positioning/etc. functionalities, as described herein.

The communication system 10 further includes a network node 16 provided in a communication system 10 and including hardware (HW) 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software (SW) 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include SRS Configuration unit 32 configured for supporting configurations for positioning and transmission collision in SRS frequency hopping.

The communication system 10 further includes the WD 22 already referred to. The WD 22 may have hardware (HW) 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software (SW) 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include SRS Control unit 34 configured for supporting configurations for positioning and transmission collision in SRS frequency hopping.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as SRS Configuration unit 32, and SRS Control unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

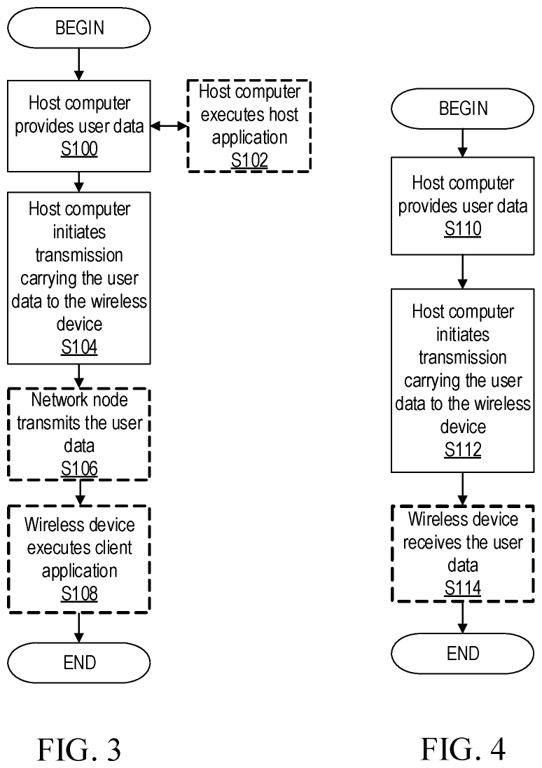

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

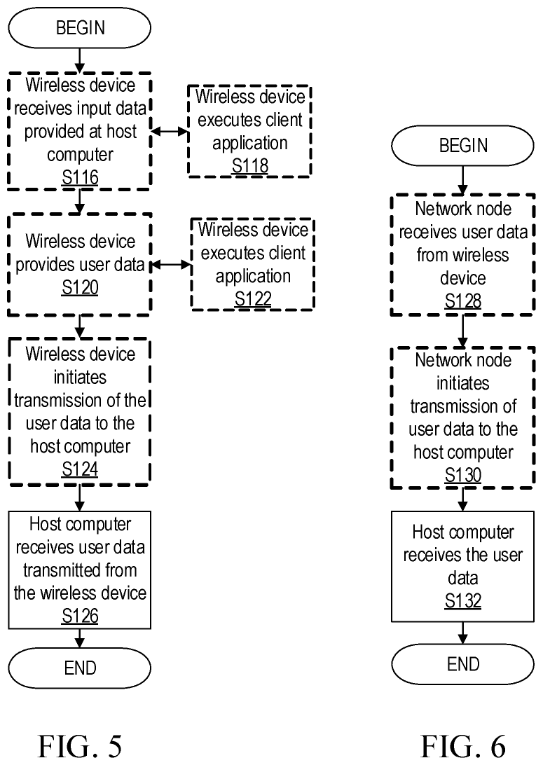

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

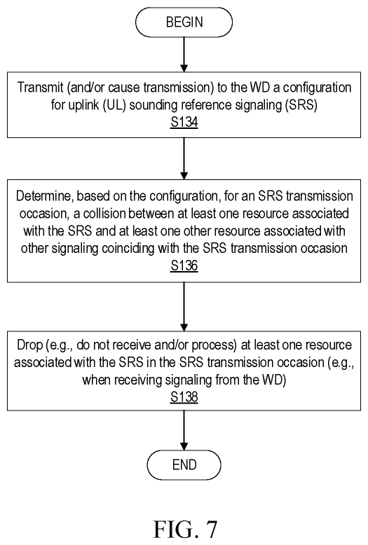

FIG. 7 is a flowchart of an exemplary process in a network node 16 for supporting configurations for positioning and transmission collision in SRS frequency hopping. One or more blocks described herein may be performed by one or more elements of network node 16 such as by one or more of processing circuitry 68 (including the SRS Configuration unit 32), processor 70, radio interface 62 and/or communication interface 60. Network node 16 is configured to transmit (Block S134) to the WD 22 a configuration for uplink (UL) sounding reference signaling (SRS). Network node 16 is configured to determine (Block S136), based on the configuration, for an SRS transmission occasion, a collision between at least one resource associated with the SRS and at least one other resource associated with other signalling coinciding with the SRS transmission occasion. Network node 16 is configured to drop (Block S138) (e.g., do not receive and/or process SRS signalling, receive and/or process other signalling on, etc.) at least one resource associated with the SRS in the SRS transmission occasion (e.g., when receiving signalling from the WD 22).

In some embodiments the other signalling includes at least one of a scheduled high priority PUSCH, a minimal required time gap for radio frequency (RF) retuning from SRS hop in one narrowband to this scheduled high priority PUSCH in other narrowband, and a minimal required time gap for RF retuning from this scheduled high priority PUSCH in one narrowband to SRS hop in another narrowband.

In some embodiments, the at least one resource of the collision is associated with a first frequency hop of a frequency hopping sequence of the SRS transmission occasion, and the network node 16 being further configured to at least one of drop at least one frequency hop following the first frequency hop in the frequency hopping sequence, and only processes the SRS stitching if full frequency hops in this frequency hop sequence would be received.

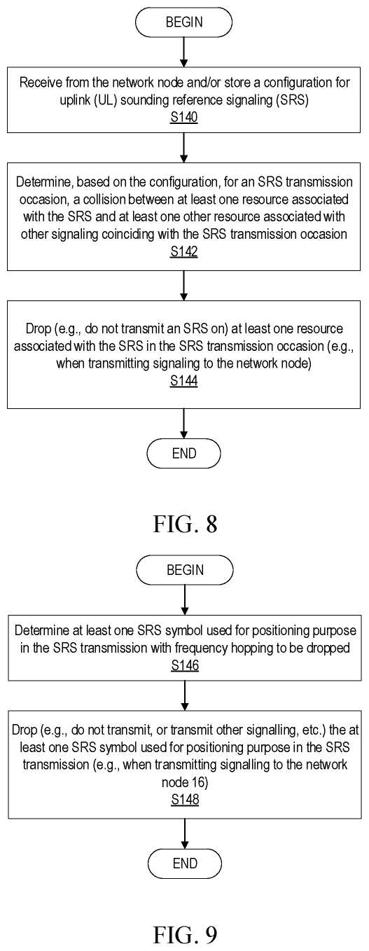

FIG. 8 is a flowchart of an exemplary process in a wireless device 22 according to some embodiments of the present disclosure for supporting configurations for positioning and transmission collision in SRS frequency hopping. One or more blocks described herein may be performed by one or more elements of wireless device 22 such as by one or more of processing circuitry 84 (including the SRS Control unit 34), processor 86, radio interface 82 and/or communication interface 60. Wireless device 22 is configured to receive (Block S140) from the network node 16 and/or store a configuration for uplink (UL) sounding reference signalling (SRS). Wireless device 22 is configured to determine (Block S142), based on the configuration, for an SRS transmission occasion, a collision between at least one resource associated with the SRS and at least one other resource associated with other signaling coinciding with the SRS transmission occasion. Wireless device 22 is configured to drop (Block S144) (e.g., do not transmit an SRS on, transmit other signalling on, etc.) at least one resource associated with the SRS in the SRS transmission occasion (e.g., when transmitting signalling to the network node 16).

In some embodiments, the other signaling includes at least one of a scheduled high priority PUSCH, a minimal required time gap for radio frequency (RF) retuning from SRS hop in one narrowband to this scheduled high priority PUSCH in other narrowband, and a minimal required time gap for RF retuning from this scheduled high priority PUSCH in one narrowband to SRS hop in another narrowband.

In some embodiments, the at least one resource of the collision is associated with a first frequency hop of a frequency hopping sequence of the SRS transmission occasion, and the WD 22 being further configured to drop at least one frequency hop following the first frequency hop in the frequency hopping sequence.

FIG. 9 is a flowchart of another exemplary process in a wireless device 22 according to some embodiments of the present disclosure for supporting positioning enhancements in SRS transmission with frequency hopping. One or more blocks described herein may be performed by one or more elements of wireless device 22 such as by one or more of processing circuitry 84 (including the SRS Control unit 34), processor 86, radio interface 82 and/or communication interface 60. Wireless device 22 is configured to determine (Block S146) at least one SRS symbol used for positioning purpose in the SRS transmission with frequency hopping to be dropped. The at least one SRS symbol used for positioning purpose in the SRS transmission collides with at least one other signaling. Wireless device 22 is configured to drop (Block S148) (e.g., do not transmit the SRS symbol for positioning, or transmit other signalling, etc.) the at least one SRS symbol used for positioning purpose in the SRS transmission (e.g., when transmitting signalling to the network node 16).

In some embodiments, wireless device 22 is further configured to receive from a network node a configuration for uplink (UL) SRS, and determine, based on the received configuration, for the SRS transmission, a collision between the at least one SRS symbol used for positioning purpose in the SRS transmission and the at least one other signaling.

In some embodiments, the collision includes at least one of: any symbol in the SRS transmission associated with a minimal required time gap for radio frequency, RF, retuning from an SRS frequency hop in one bandwidth part to a scheduled PUSCH in another bandwidth part; any symbol in the SRS transmission associated with a minimal required time gap for RF retuning from a scheduled PUSCH in one bandwidth part to an SRS frequency hop in another bandwidth part.

In some embodiments, the at least one other signaling includes at least one of: a scheduled PUSCH with a priority index 1; and an SRS transmission for other purpose than for positioning purpose.

In some embodiments, the at least one SRS symbol used for positioning purpose of the collision is associated with a frequency hop of a frequency hopping sequence in the SRS transmission. The WD 22 may be further configured to perform at least one of: dropping the frequency hop in the frequency hopping sequence, dropping at least one frequency hop following the frequency hop in the frequency hopping sequence, and transmitting all remaining frequency hops following the frequency hop in the frequency hopping sequence.

In some embodiments, wireless device 22 is further configured to transmit, to the network node 16, the SRS transmission with frequency hopping comprising the at least one other signaling rather than the at least one SRS symbol used for positioning purpose.

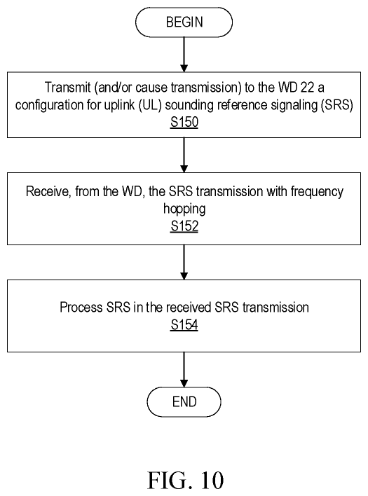

FIG. 10 is a flowchart of another exemplary process in a network node 16 for supporting positioning enhancements in SRS transmission with frequency hopping. One or more blocks described herein may be performed by one or more elements of network node 16 such as by one or more of processing circuitry 68 (including the SRS Configuration unit 32), processor 70, radio interface 62 and/or communication interface 60. Network node 16 is configured to transmit (Block S150) to the WD 22 a configuration for uplink (UL) sounding reference signaling (SRS). Network node 16 is configured to receive (Block S152), from the WD, the SRS transmission with frequency hopping based on the transmitted configuration. Network node 16 is configured to process (Block S154) SRS in the received SRS transmission. The received SRS transmission comprises at least one other signaling rather than at least one SRS symbol used for positioning purpose. The at least one SRS symbol used for positioning purpose collides with the at least one other signaling and is dropped.

In some embodiments, the collision includes at least one of: any symbol in the SRS transmission associated with a minimal required time gap for radio frequency, RF, retuning from an SRS frequency hop in one bandwidth part to a scheduled PUSCH in another bandwidth part; any symbol in the SRS transmission associated with a minimal required time gap for RF retuning from a scheduled PUSCH in one bandwidth part to an SRS frequency hop in another bandwidth part.

In some embodiments, the at least one other signaling includes at least one of: a scheduled PUSCH with a priority index 1; and an SRS transmission for other purpose than for positioning purpose.

In some embodiments, the at least one SRS symbol used for positioning purpose of the collision is associated with a frequency hop of a frequency hopping sequence in the SRS transmission. The process performed by the network node 16 may further include at least one of: the frequency hop in the frequency hopping sequence is dropped; at least one frequency hop following the frequency hop in the frequency hopping sequence is dropped; and receiving all remaining frequency hops following the frequency hop in the frequency hopping sequence.

Embodiments of the present disclosure may allow the wireless device to save power, e.g., by avoiding transmitting SRS resources which would not be usable for the purpose they were configured for, e.g. bandwidth hopping.

Embodiments of the present disclosure may be used to solve a collision between UL SRS transmission and scheduled PUSCH/PUCCH transmission.

Having described the general process flow of arrangements of the disclosure and having provided examples of hardware and software arrangements for implementing the processes and functions of the disclosure, the sections below provide details and examples of arrangements for supporting configurations for positioning and transmission collision in SRS frequency hopping.

As used herein, the terminology “narrowband” may be interchangeable with the terminology “bandwidth part, BWP”.

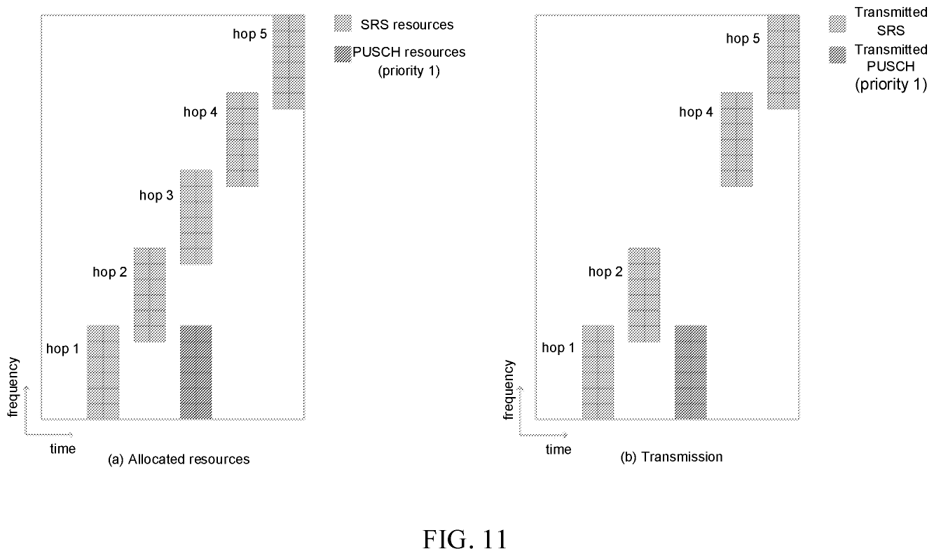

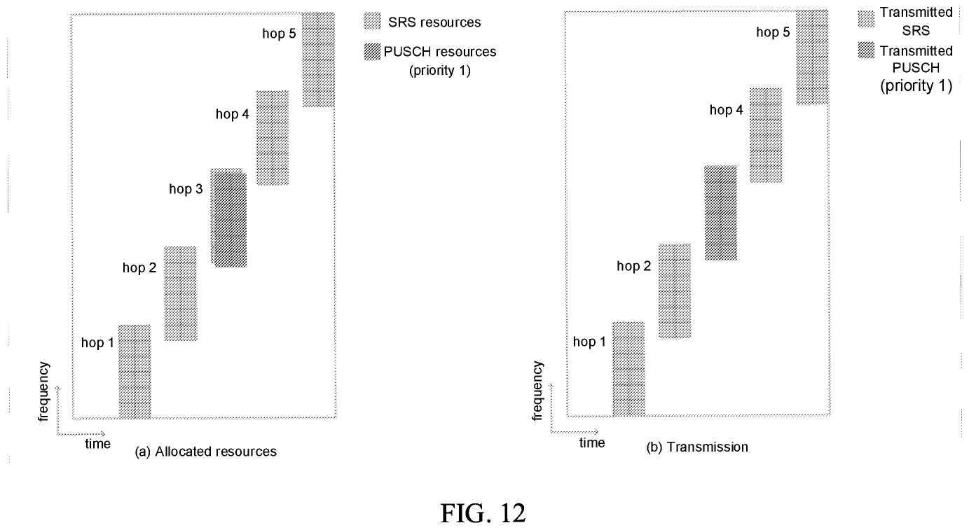

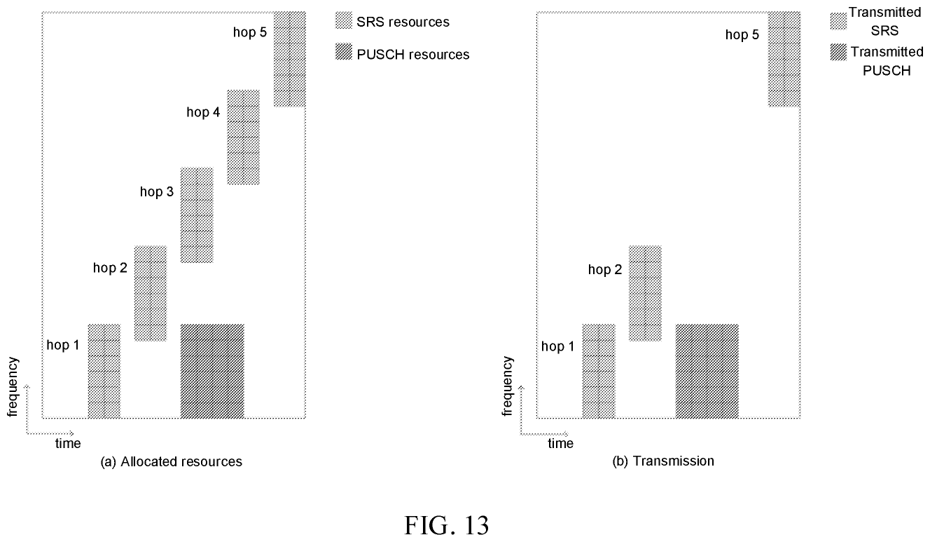

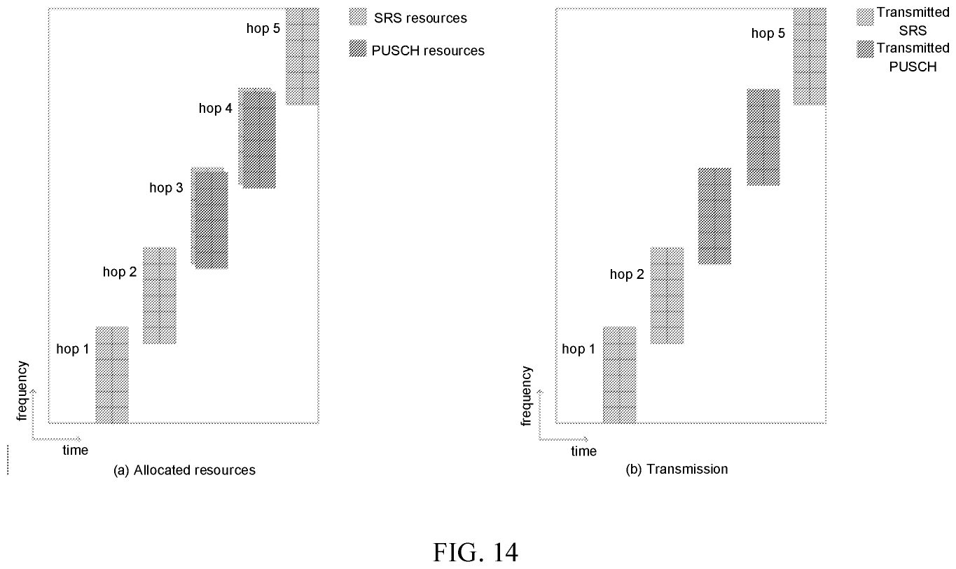

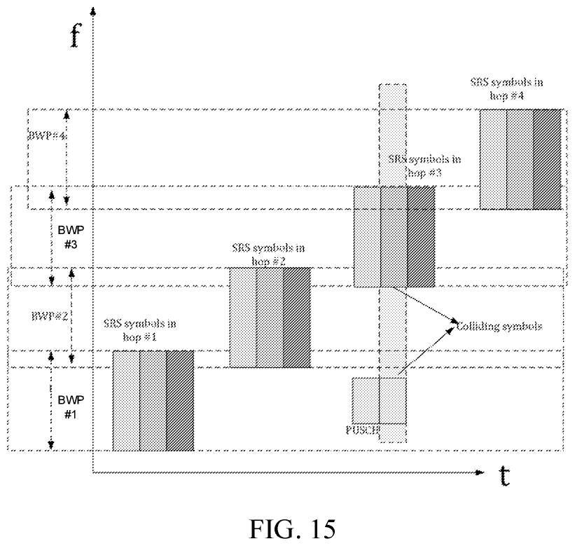

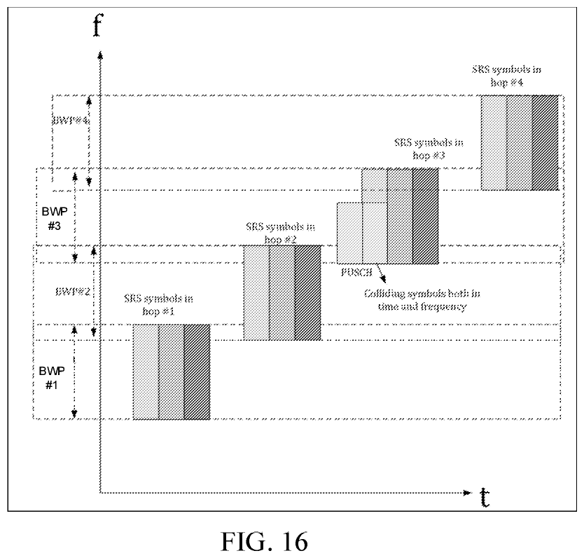

In some embodiments, when SRS transmission is configured for frequency hopping, e.g., for RedCap UL positioning, there may be several scenarios where the SRS symbols may be colliding with the scheduled PUSCH/PUCCH. FIG. 11, FIG. 12, FIG. 13, FIG. 14, FIG. 15, and FIG. 16 provide example scenarios and configurations according to some embodiments of the present disclosure.

FIG. 11 and FIG. 12 illustrate an example of configured SRS positioning full overlapping with scheduled PUSCH/PUCCH and scheduled SRS for other purpose(s) than positioning. FIG. 11 illustrates an example configuration using fixed active BWP. FIG. 12 illustrates an example configuration using changed active BWP. As shown in the example of FIG. 11 and FIG. 12, SRS transmission in hop 3 is fully colliding with the scheduled PUSCH transmission with priority 1.

FIG. 13 and FIG. 14 illustrate an example of configured SRS positioning symbols full overlapping with scheduled PUSCH/PUCCH and SRS for other purpose(s). FIG. 13 illustrates an example configuration using fixed active BWP. FIG. 14 illustrates an example configuration using changed active BWP. As shown in FIG. 13 and FIG. 14, SRS transmission in hop 3 and hop 4 is colliding with the scheduled PUSCH transmission with priority 1 in the same symbols and in the symbols as time gap for RF retuning.

FIG. 15 illustrates an example of configured SRS positioning symbols partially overlapping with scheduled PUSCH/PUCCH and SRS for other purpose(s) than positioning in different BWP. In FIG. 15, the SRS configured symbols are colliding partially with the scheduled PUSCH/PUCCH and such colliding is only in time domain, the scheduled PUSCH and configured SRS belong to different BWPs.

FIG. 16 illustrates an example of configured SRS positioning symbols partially overlapping with scheduled PUSCH/PUCCH and SRS for other purpose(s) than positioning within the same BWP. In FIG. 16, the SRS configured symbols are colliding partially with the scheduled PUSCH/PUCCH and such colliding is only in time domain, the scheduled PUSCH and configured SRS belong to same BWPs.

The SRS configuration may be periodic, aperiodic and semi-persistent. As the priority of the aperiodic is higher than semi-persistent and periodic, one or more of the embodiments described herein may also be applied when SRS for positioning is configured with periodic (or semi-persistent) and when conflicting with other SRS configuration, the SRS for positioning symbols may be dropped.

In some embodiments, e.g., in the case of the PUSCH/PUCCH symbols fully overlapping with SRS symbols in one frequency hop and if the overlapping symbol is in the same BWP, then SRS symbols may be dropped. The dropped SRS symbol will impact the estimation accuracy of time of arrival significantly. In this case, the WD 22 may be configured to drop this SRS transmission in the conflicted hops in one SRS occasion which includes a whole SRS frequency hopping cross the target wideband. This corresponds to the scenarios shown in the examples of FIG. 11, FIG. 12, FIG. 13, and FIG. 14.

In some embodiments, e.g., in the case of the PUSCH/PUCCH symbols fully overlapping with SRS symbols in one frequency hop and if the conflicted symbol appears in the case where SRS is transmitted in a BWP/narrowband which is different from the BWP/narrowband for scheduled PUSCH transmission, then the WD 22 may be configured to jump to the BWP/narrowband which is for PUSCH transmission, and thus all SRS symbols are dropped. In some embodiments, the WD 22 may be configured to drop the remaining SRS transmission in other frequency hops in a whole SRS frequency hopping pattern across the target wideband.

In some embodiments, the collision with the scheduled PUSCH/PUCCH may occur during any hop at the beginning, middle and/or end of the full frequency hopping sequence (FH1, FH2, . . . , FHk). The collision of SRS and PUSCH/PUCCH may occur only partially in at least one FH depending on how many SRS symbols are configured to transmit within each hop and/or depending how many SRS resources is configured on different symbols. This is illustrated in the examples of FIG. 15 and FIG. 16, e.g., the collision includes the symbols for high priority PUSCH/PUCCH transmission, and the symbols used for RF retuning from SRS hop in one BWP/narrowband to be scheduled high priority PUSCH/PUCCH in another BWP/narrowband and the symbols used for RF retuning from scheduled high priority PUSCH/PUCCH in one narrowband to SRS hop in another narrowband, as configured in the WD 22 and/or network node 16.

In some embodiments, if the collision symbols of SRS and PUSCH/PUCCH with priority index 1 are all symbols scheduled for SRS transmission for this hop and the collision slot (another example is the “collision hop”) is the first hop, middle hop, or end hop within a frequency hopping sequence, the WD 22 may be configured to drop the frequency hops following the collision hop in the frequency hopping sequence. In this case, the network node 16 may be configured to only processes the SRS stitching if full frequency hops in this frequency hop sequence would be received.

In some embodiments, if the collision symbols of SRS and PUSCH/PUCCH with priority index 1 are all symbols scheduled for SRS transmission for this hop and the collision slot (another example is the “collision hop”) is the first or middle hop within a frequency hopping sequence, the WD 22 may be configured such that it will not drop the rest of the frequency hops but may continue with the rest of the hops for the configure FH pattern/sequency. In this case, the network node 16 may be configured such that it may process the SRS stitching if partially frequency hops would be received. In this case, the network node 16 may be configured to inform the location server (e.g., as implemented by host computer 24) of at least one of aggregated bandwidth for the measurement results (e.g., timing of arrival, related timing difference, and so on), measurement accuracy, measurement uncertainty, etc.

In some embodiments, the collision of SRS symbol only happens partially at one SRS symbol and such SRS symbol is configured with different SRS port than other SRS symbol, dropping the SRS symbol in this hop shall not incur further SRS symbols drop in the remaining frequency hops. However, in the remaining frequency hops, the SRS symbol associated with the same SRS port with the dropped SRS symbol may also be dropped, e.g., based on the WD 22 configuration.

In some embodiments, where the collision of SRS symbol only happens partially at one SRS symbol and such SRS symbol is configured with repetition of same SRS port symbols, for the remaining frequency hops, there may be no need to drop. This may be because the network node 16 (e.g., a base station) may still be able to use the transmitted SRS to stitch the remaining SRS transmission in the remaining frequency hops. This may be the case, e.g., where network node 16 may still be able to receive the rest repetition SRS symbol associated with SRS port. If the network node 16 cannot decode the rest repetition SRS symbol, the network node 16 may be configured to transmit a signalling to the WD 22 to drop the rest of the frequency hopping. Alternatively, in the case of repetition SRS symbol is dropped, the WD 22 may be configured to drop the rest of the frequency hops in other BWP.

In some embodiments, the same collision dropping rule defined/configured in legacy specification may be applied (e.g., by WD 22 and/or network node 16) within each SRS hop.

In some embodiments, if the collision symbols of SRS and PUSCH/PUCCH with priority index 1 are all symbols scheduled for SRS transmission for this hop and the collision slot (another example is the “collision hop”) is the first hop, middle hop, or end hop within a frequency hopping sequence, then the following may apply:
WD 22 behavior (e.g., based on configuration information, based on expected/configured behavior of the network node 16, etc.):
   Alternative 1: WD 22 may 1 drop the frequency hops following the collision hop in the frequency hopping sequence.
   Alternative 2: WD 22 may drop the collision hop and the following frequency hops in the frequency hopping sequence.
   Alternative 3: WD 22 may drop the collision hop in the frequency hopping sequence.
Network node 16 behavior (e.g., based on configuration information, based on expected/configured behavior of the WD 22, etc.):
   Alternative 1: network node 16 may only process the SRS stitching if full frequency hops in this frequency hop sequence would be received.
   Alternative 2: network node 16 may only process the SRS stitching if full frequency hops in this frequency hop sequence have been detected.
   Alternative 3: network node 16 may only process the SRS stitching if partially frequency hops would be received. In other words, the network, e.g., network node 16, only processes the transmitted SRS hops in this frequency hop sequence.
   Alternative 4: network node 16 may only process the detected SRS hops in this frequency hop sequence.
   In some embodiments, the network node 16 may be configured to inform the location server (e.g., as implemented by host computer 24) of at least one of the aggregated bandwidth, the symbols in each hop and the minimal available SRS symbols in the hops for the related measurement results (e.g., timing of arrival, related timing difference, and so on), for example from the network to the location server (e.g., as implemented by host computer 24).
   In some embodiments, the network node 16 may inform the location server (e.g., as implemented by host computer 24) of the reason of the failure of the measurement.

In some embodiments, if a PUSCH transmission with a priority index 1 or a PUCCH transmission with a priority index 1 would overlap in time with an SRS transmission for the purpose of bandwidth hopping on a serving cell, the WD 22 may be configured such that it does not transmit any symbol of the SRS resource and does not transmit the SRS resource(s) configured for the same bandwidth hopping.

In some embodiments, for operation on the same wideband carrier, if any symbol of any resource involved in an SRS transmission occasion configured by the network collides with any symbol of a scheduled high priority PUSCH/PUCCH in time domain or collides with the minimal required time gap for RF retuning from SRS hop in one narrowband to this scheduled high priority PUSCH in another narrowband in time domain or collides with the minimal required time gap for RF retuning from this scheduled high priority PUSCH in one narrowband to SRS hop in another narrowband, the SRS in all resources in this SRS transmission occasion may be dropped (e.g., based on a WD 22 configuration and/or network node 16 configuration). Alternatively, only SRS in collision symbol(s) may be configured to be dropped.

In some embodiments, if a PUSCH with a priority index 0 and an SRS configured by SRS-PosResource for the purpose of bandwidth hopping are transmitted in the same slot on a serving cell, the WD 22 may only be configured to transmit SRS after the transmission of the PUSCH and the corresponding DM-RS.

In some embodiments, the same rule applied (e.g., by WD 22 and/or network node 16 based, e.g., on configuration information) if the SRS for positioning symbol is colliding/overlapped with the SRS for other purpose(s).

In some embodiments, the location server may be implemented by host computer 24. In some embodiments, the location server may be implemented by and/or reside in core network 14. In some embodiments, the location server may be implemented by a network node 16.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

Some example embodiments of the present disclosure are as follows:

### Embodiments

Embodiment A1. A network node configured to communicate with a wireless device (WD), the network node configured to, and/or comprising a radio interface and/or comprising processing circuitry configured to:
transmit (and/or cause transmission) to the WD a configuration for uplink (UL) sounding reference signaling (SRS);
determine, based on the configuration, for an SRS transmission occasion, a collision between at least one resource associated with the SRS and at least one other resource associated with other signaling coinciding with the SRS transmission occasion; and
drop (e.g., do not receive and/or process) at least one resource associated with the SRS in the SRS transmission occasion (e.g., when receiving signaling from the WD).

Embodiment A2. The network node of Embodiment A1, wherein the other signaling includes at least one of:
a scheduled high priority PUSCH;
a minimal required time gap for radio frequency (RF) retuning from SRS hop in one narrowband to this scheduled high priority PUSCH in other narrowband; and
a minimal required time gap for RF retuning from this scheduled high priority PUSCH in one narrowband to SRS hop in another narrowband.

Embodiment A3. The network node of any of Embodiments A1 and A2, wherein the at least one resource of the collision is associated with a first frequency hop of a frequency hopping sequence of the SRS transmission occasion; and
the network node being further configured to at least one of:
   drop at least one frequency hop following the first frequency hop in the frequency hopping sequence; and
   only processes the SRS stitching if full frequency hops in this frequency hop sequence would be received.

Embodiment B1. A method implemented in a network node, the method comprising:
transmitting to the WD a configuration for uplink (UL) sounding reference signaling (SRS);
determining, based on the configuration, for an SRS transmission occasion, a collision between at least one resource associated with the SRS and at least one other resource associated with other signaling coinciding with the SRS transmission occasion; and
dropping (e.g., do not receive and/or process) at least one resource associated with the SRS in the SRS transmission occasion (e.g., when receiving signaling from the WD).

Embodiment B2. The method of Embodiment B1, wherein the other signaling includes at least one of:
a scheduled high priority PUSCH;
a minimal required time gap for radio frequency (RF) retuning from SRS hop in one narrowband to this scheduled high priority PUSCH in other narrowband; and
a minimal required time gap for RF retuning from this scheduled high priority PUSCH in one narrowband to SRS hop in another narrowband.

Embodiment B3. The method of any of Embodiments B1 and B2, wherein the at least one resource of the collision is associated with a first frequency hop of a frequency hopping sequence of the SRS transmission occasion; and
the method further comprising at least one of:
   drop at least one frequency hop following the first frequency hop in the frequency hopping sequence; and
   only processes the SRS stitching if full frequency hops in this frequency hop sequence would be received.

Embodiment C1. A wireless device (WD) configured to communicate with a network node, the WD configured to, and/or comprising a radio interface and/or processing circuitry configured to:
receive from the network node and/or store a configuration for uplink (UL) sounding reference signaling (SRS);
determine, based on the configuration, for an SRS transmission occasion, a collision between at least one resource associated with the SRS and at least one other resource associated with other signaling coinciding with the SRS transmission occasion; and
drop (e.g., do not transmit an SRS on) at least one resource associated with the SRS in the SRS transmission occasion (e.g., when transmitting signaling to the network node).

Embodiment C2. The WD of Embodiment C1, wherein the other signaling includes at least one of:
a scheduled high priority PUSCH;
a minimal required time gap for radio frequency (RF) retuning from SRS hop in one narrowband to this scheduled high priority PUSCH in other narrowband; and
a minimal required time gap for RF retuning from this scheduled high priority PUSCH in one narrowband to SRS hop in another narrowband.

Embodiment C3. The WD of any of Embodiments C1 and C2, wherein the at least one resource of the collision is associated with a first frequency hop of a frequency hopping sequence of the SRS transmission occasion; and
the WD being further configured to drop at least one frequency hop following the first frequency hop in the frequency hopping sequence.

Embodiment D1. A method implemented in a wireless device (WD), the method comprising:
receiving from a network node and/or storing a configuration for uplink (UL) sounding reference signaling (SRS);
determining, based on the configuration, for an SRS transmission occasion, a collision between at least one resource associated with the SRS and at least one other resource associated with other signaling coinciding with the SRS transmission occasion; and
dropping at least one resource associated with the SRS in the SRS transmission occasion.

Embodiment D2. The method of Embodiment D1, wherein the other signaling includes at least one of:
a scheduled high priority PUSCH;
a minimal required time gap for radio frequency (RF) retuning from SRS hop in one narrowband to this scheduled high priority PUSCH in other narrowband; and
a minimal required time gap for RF retuning from this scheduled high priority PUSCH in one narrowband to SRS hop in another narrowband.

Embodiment D3. The method of any of Embodiments D1 and D2, wherein the at least one resource of the collision is associated with a first frequency hop of a frequency hopping sequence of the SRS transmission occasion; and
the method further comprising dropping at least one frequency hop following the first frequency hop in the frequency hopping sequence.

1. A method implemented in a wireless device, WD, for sounding reference signaling, SRS, transmission with frequency hopping, the method comprising:
determining at least one SRS symbol used for positioning purpose in the SRS transmission with frequency hopping to be dropped, the at least one SRS symbol used for positioning purpose in the SRS transmission colliding with at least one other signaling; and
dropping the at least one SRS symbol used for positioning purpose in the SRS transmission.

2. The method of claim 1, the method further comprising:
receiving from a network node a configuration for uplink, UL, SRS;
determining, based on the received configuration, for the SRS transmission, a collision between the at least one SRS symbol used for positioning purpose in the SRS transmission and the at least one other signaling.

3. The method of claim 1, wherein the collision includes at least one of:
any symbol in the SRS transmission associated with a minimal required time gap for radio frequency, RF, retuning from an SRS frequency hop in one bandwidth part to a scheduled PUSCH in another bandwidth part;
any symbol in the SRS transmission associated with a minimal required time gap for RF retuning from a scheduled PUSCH in one bandwidth part to an SRS frequency hop in another bandwidth part.

4. The method of claim 1, wherein the at least one other signaling includes at least one of:
a scheduled PUSCH with a priority index 1; and
an SRS transmission for other purpose than for positioning purpose.

5. The method of claim 1, wherein the at least one SRS symbol used for positioning purpose of the collision is associated with a frequency hop of a frequency hopping sequence in the SRS transmission.

6. The method of claim 5, the method further comprising at least one of:
dropping the frequency hop in the frequency hopping sequence;
dropping at least one frequency hop following the frequency hop in the frequency hopping sequence; and
transmitting all remaining frequency hops following the frequency hop in the frequency hopping sequence.

7. The method of claim 1, the method further comprising:
transmitting, to the network node, the SRS transmission with frequency hopping comprising the at least one other signaling rather than the at least one SRS symbol used for positioning purpose.

8. A wireless device, WD, configured to communicate sounding reference signaling, SRS, transmission with frequency hopping with a network node, the WD configured to, and/or comprising a radio interface and/or processing circuitry configured to:
determine at least one SRS symbol used for positioning purpose in the SRS transmission with frequency hopping to be dropped, the at least one SRS symbol used for positioning purpose in the SRS transmission colliding with at least one other signaling; and
drop the at least one SRS symbol used for positioning purpose in the SRS transmission.

9. The WD of claim 8, the WD being further configured to:
receive from the network node a configuration for uplink, UL, SRS;
determine, based on the received configuration, for the SRS transmission, a collision between the at least one SRS symbol used for positioning purpose in the SRS transmission and the at least one other signaling.

10. The WD of claim 8, wherein the collision includes at least one of:
any symbol in the SRS transmission associated with a minimal required time gap for radio frequency, RF, retuning from an SRS frequency hop in one bandwidth part to a scheduled PUSCH in another bandwidth part;
any symbol in the SRS transmission associated with a minimal required time gap for RF retuning from a scheduled PUSCH in one bandwidth part to an SRS frequency hop in another bandwidth part.

11. The WD of claim 8, wherein the at least one other signaling includes at least one of:
a scheduled PUSCH with a priority index 1; and
an SRS transmission for other purpose than for positioning purpose.

12. The WD of any claim 8, wherein the at least one SRS symbol used for positioning purpose of the collision is associated with a frequency hop of a frequency hopping sequence in the SRS transmission.

13. (canceled)

14. (canceled)

15. A method implemented in a network node for sounding reference signaling, SRS, transmission with frequency hopping, the method comprising:
transmitting to a wireless device, WD, a configuration for uplink, UL, SRS;
receiving from the WD the SRS transmission with frequency hopping based on the configuration, the received SRS transmission comprises at least one other signaling rather than at least one SRS symbol used for positioning purpose; and
processing SRS in the received SRS transmission, the received SRS transmission comprising at least one other signaling rather than at least one SRS symbol used for positioning purpose, and the at least one SRS symbol used for positioning purpose colliding with the at least one other signaling and is dropped.

16. The method of claim 15, wherein the collision includes at least one of:
any symbol in the SRS transmission associated with a minimal required time gap for radio frequency, RF, retuning from an SRS frequency hop in one bandwidth part to a scheduled PUSCH in another bandwidth part;
any symbol in the SRS transmission associated with a minimal required time gap for RF retuning from a scheduled PUSCH in one bandwidth part to an SRS frequency hop in another bandwidth part.

17. The method of claim 15, wherein the at least one other signaling includes at least one of:
a scheduled PUSCH with a priority index 1; and
an SRS transmission for other purpose than for positioning purpose.

18. The method of claim 15, the at least one SRS symbol of the collision is associated with a frequency hop of a frequency hopping sequence in the SRS transmission.

19. (canceled)

20. (canceled)

21. A network node configured to communicate sounding reference signaling, SRS, transmission with frequency hopping with a wireless device, WD, the network node configured to:
transmit to the WD a configuration for uplink, UL, SRS;
receiving from the WD the SRS transmission with frequency hopping based on the configuration; and
process SRS in the received SRS transmission, the received SRS transmission comprising at least one other signaling rather than at least one SRS symbol used for positioning purpose, and the at least one SRS symbol used for positioning purpose colliding with the at least one other signaling and is dropped.

22. The network node of claim 21, wherein the collision includes at least one of:
any symbol in the SRS transmission associated with a minimal required time gap for radio frequency, RF, retuning from an SRS frequency hop in one bandwidth part to a scheduled PUSCH in another bandwidth part;
any symbol in the SRS transmission associated with a minimal required time gap for RF retuning from a scheduled PUSCH in one bandwidth part to an SRS frequency hop in another bandwidth part.

23. The network node of claim 21, wherein the at least one other signaling includes at least one of:
a scheduled PUSCH with a priority index 1; and
an SRS transmission for other purpose than for positioning purpose.

24. The network node of claim 21, the at least one SRS symbol of the collision is associated with a frequency hop of a frequency hopping sequence in the SRS transmission.

25. (canceled)

26. (canceled)
